(19) United States
(12) Patent Application Publication
(10) Pub. No.: US 2023/0361388 A1
(43) Pub. Date: Nov. 9, 2023

(54) COOLING A BATTERY BY IMMERSION IN A COMPOSITION WITH A CHANGE IN STATE

(71) Applicant: ARKEMA FRANCE, Colombes (FR)

(72) Inventors: Dominique GARRAIT, Pierre-Benite Cedex (FR); Laurent ABBAS, Pierre-Benite Cedex (FR)

(73) Assignee: ARKEMA FRANCE, Colombes (FR)

(21) Appl. No.: 18/246,560

(22) PCT Filed: Oct. 1, 2021
(86) PCT No.: PCT/FR2021/051701

§ 371 Date: Mar. 24, 2023

(30) Foreign Application Priority Data
Oct. 19, 2020 (FR) FR2010702
May 18, 2021 (FR) FR2105144

(51) Int. Cl. H01M 10/6569; B60H 1/00; H01M 10/613; H01M 10/625

(52) U.S. Cl. CPC H01M 10/6569; B60H 1/00278; B60H 1/00392; H01M 10/613; H01M 10/625; H01M 2220/20

(57) ABSTRACT

The use of a heat-transfer composition comprising from 20% to less than 100% by weight of a refrigerant including a compound chosen from halogenated hydrocarbons, perhalogenated compounds, fluorinated ketones, fluorinated ethers and also their combinations, and from more than 0% to 80% by weight of a dielectric fluid, for cooling a battery, the battery including energy storage cells immersed in the heat-transfer composition, and the heat-transfer composition undergoing evaporation on contact with the energy storage cells.

### FIELD OF THE INVENTION

The present invention relates to the use of a heat-transfer composition comprising at least one refrigerant and at least one dielectric fluid, to cool a battery. The invention applies in particular to the batteries of electric or hybrid vehicles.

### TECHNICAL BACKGROUND

The need to dissipate high thermal flows is essential in several applications, in particular the cooling of batteries. Liquid-vapor phase change cooling proves to be an effective solution for the dissipation of large amounts of heat while keeping the temperature of the battery in its optimum temperature range and while having a uniform temperature of the system.

In particular, the batteries of electric or hybrid vehicles give a maximum output under specific conditions of use and especially in a very specific temperature range. Thus, in cold climates, the range of electric or hybrid vehicles presents a problem, all the more so since the high heating requirements consume a large proportion of the stored electrical energy. In addition, at low temperatures, the available power of the battery is low, which presents a driving problem. Moreover, the cost of the battery contributes massively to the cost of the electric or hybrid vehicle.

Conversely, the cooling of the battery is a dominating safety issue. Various dielectric oils can be used to cool the battery of an electric or hybrid vehicle. However, when rapid charging of the battery is required, the use of a single-phase cooling system using, for example, dielectric oils alone is not sufficient to efficiently cool the battery. In this case, a cooling system with a phase change of the heat composition has to be envisaged. Fluids, such as, for example, refrigerants, which are more volatile and less viscous, should be used. However, these fluids exhibit higher vapor pressures than those observed in the case of dielectric oils, which may require reinforcement of the casing of the battery (and thus an increase in its weight) in order to withstand the pressure. These fluids are moreover more expensive than dielectric oils. They also have a much higher density than dielectric fluids, which can weigh down the system.

Furthermore, it is important to use, in the vicinity of the battery, compositions which are sparingly flammable or non-flammable in order to eliminate any risk associated with the safety of the use of these compositions.

The document FR 2 973 809 relates to the use of a zeolite adsorbent for improving the thermal stability of an oil subjected to temperature variations in coolant compositions.

The document FR 2 962 442 relates to a stable composition comprising 2,3,3,3-tetrafluoropropene, for use in refrigeration and air conditioning.

The document US 2014/057826 relates to a heat-transfer composition comprising at least one hydrochlorofluoroolefin used for air conditioning, refrigeration and heat pump applications or used for the cleaning of products, components, substrates or other articles containing the substance to be cleaned.

The document WO 2019/242977 relates to a fluid-insulated switchgear which comprises a fluid compartment filled with an electrically insulating fluid and an electrical conductor located in the fluid compartment and electrically insulated by the electrically insulating fluid.

The document WO 2019/162598 relates to the use of a refrigerant comprising 2,3,3,3-tetrafluoropropene for keeping the temperature of a battery of an electric or hybrid vehicle in a temperature range.

The document WO 2019/162599 relates to the use of a refrigerant comprising 2,3,3,3-tetrafluoropropene for the preheating of a battery of an electric or hybrid vehicle starting from the moving off of the vehicle.

The document WO 2019/197783 relates to a process for cooling and/or heating a body or a fluid in a motor vehicle, by means of a system comprising a vapor compression circuit in which a first heat-transfer composition circulates and a secondary circuit in which a second heat-transfer composition circulates.

The documents WO 2020/011888, WO 2020/100152, WO 2020/007954, U.S. Pat. Nos. 9,865,907, 10,784,545, FR 3 037 727, FR 3 075 471, FR 3 085 542, FR 3 085 545, FR 3 085 547, FR 3 085 556 and EP 3 499 634 describe systems for thermal regulation of batteries by direct contact with a fluid.

There exists a need to ensure optimal operation of batteries, in particular of electric or hybrid vehicles, so as to provide high-performance batteries, having long lifetimes and improved safety, without increasing the costs.

### SUMMARY OF THE INVENTION

The invention relates first to the use of a heat-transfer composition comprising from 20% to less than 100% by weight of a refrigerant comprising a compound chosen from halogenated hydrocarbons, perhalogenated compounds, fluorinated ketones, fluorinated ethers and also their combinations, and from more than 0% to 80% by weight of a dielectric fluid, for cooling a battery, the battery comprising energy storage cells immersed in the heat-transfer composition, and the heat-transfer composition undergoing evaporation on contact with the energy storage cells.

In some embodiments, the heat-transfer composition circulates in a heat-transfer circuit.

In some embodiments, the battery comprises one or more modules each comprising an enclosure in which energy storage cells are arranged, the enclosure(s) forming part of the heat-transfer circuit.

In some embodiments, the heat-transfer circuit is thermally coupled to a secondary circuit containing an additional transfer composition.

In some embodiments, the secondary circuit is the air conditioning circuit of a vehicle; and/or is a reversible heat pump circuit.

In some embodiments, the refrigerant comprises or is 1-chloro-3,3,3-trifluoropropene, preferably in the E form, or is a binary mixture, preferably azeotropic, of 1-chloro-3,3,3-trifluoropropene in the Z form and of 1,1,1,2,3-pentafluoropropane, or of 1,1,1,4,4,4-hexafluorobut-2-ene in the Z form and of 1,2-dichloroethylene in the E form.

In some embodiments, the dielectric fluid is chosen from mineral dielectric oils, synthetic dielectric oils and vegetable dielectric oils; and preferably from aromatic hydrocarbons chosen from alkylbenzenes, alkyldiphenylethanes, alkylnaphthalenes, methylpolyarylmethanes and also their combinations, poly(α-)olefins and polyol esters.

In some embodiments, the battery is the battery of an electric or hybrid vehicle, preferably of an electric or hybrid automobile.

In some embodiments, the use is implemented during the charging of the battery of the vehicle, the battery of the vehicle preferably being fully charged in a period of time of less than or equal to 30 min, and preferably of less than or equal to 15 min, starting from its full discharge.

The invention also relates to a battery assembly, in particular for an electric or hybrid vehicle, comprising one or more modules each comprising an enclosure in which are arranged energy storage cells immersed in a heat-transfer composition, the heat-transfer composition comprising from 20% to less than 100% by weight of a refrigerant comprising a compound chosen from halogenated hydrocarbons, perhalogenated compounds, fluorinated ketones, fluorinated ethers as well as their combinations, and from more than 0% to 80% by weight of a dielectric fluid, the battery assembly being configured so that the heat-transfer composition undergoes evaporation in order to cool the battery.

In some embodiments, the assembly comprises a heat-transfer circuit in which the heat-transfer composition circulates, the enclosure(s) of the module(s) being incorporated in this heat-transfer circuit.

In some embodiments, the heat-transfer circuit comprises a pump; and/or the heat-transfer circuit comprises a heat exchanger in order to make possible heat exchange of the heat-transfer composition either with the ambient air or with a heat-transfer composition in a secondary circuit.

In some embodiments, the refrigerant comprises or is 1-chloro-3,3,3-trifluoropropene, preferably in the E form, or is a binary mixture, preferably azeotropic, of 1-chloro-3,3,3-trifluoropropene in the Z form and of 1,1,1,2,3-pentafluoropropane, or of 1,1,1,4,4,4-hexafluorobut-2-ene in the Z form and of 1,2-dichloroethylene in the E form.

In some embodiments, the dielectric fluid is chosen from mineral dielectric oils, synthetic dielectric oils and vegetable dielectric oils; and preferably from alkylbenzenes, alkyldiphenylethanes, alkylnaphthalenes, methylpolyarylmethanes and also their combinations, poly(α-)olefins and polyol esters.

The invention also relates to a method of regulation of the temperature of the battery of the battery assembly described above, comprising the cooling of the energy storage cells by the heat-transfer composition by partial evaporation of the heat-transfer composition.

The present invention makes it possible to meet the need expressed above. This is because it makes it possible to ensure optimal operation of the item of equipment, in particular an electric or hybrid vehicle battery (in particular the traction battery of the vehicle), so as to provide high-performance batteries, having long lifetimes and improved safety, without increasing the costs.

This is accomplished by virtue of the use of a heat-transfer composition comprising from 20% to less than 100% by weight of a refrigerant chosen from halogenated hydrocarbons, perhalogenated compounds, fluorinated ketones, fluorinated ethers and also their combinations, and from more than 0% to 80% of a dielectric fluid, the energy storage cells of the battery being immersed in the heat-transfer composition, and the heat-transfer composition undergoing evaporation on contact with the energy storage cells.

This is because the combination of a dielectric fluid with a refrigerant makes it possible to maintain heat-transfer properties far superior to those of a liquid-phase dielectric fluid.

Compared to the use of a refrigerant alone, the invention makes it possible to reduce the cost and the weight without appreciable degradation of the performance qualities of the battery, of the lifetime or of safety.

In addition, the vapor pressure of the composition is generally lower than that of the refrigerant alone, which makes it possible to reduce the constraints of reinforcement of the facility.

Thus, the invention makes it possible generally to increase the efficiency and the lifetime of the batteries, in particular during fast charging, without increasing the costs.

Preferably, the refrigerant has a boiling point of less than 50° C., more preferably of less than 30° C. and in particular of less than 25° C. or 20° C. (at 1 bar). A relatively low boiling point can help in slowing down propagation in the event of thermal runaway of the battery.

Preferably, the composition exhibits a volume resistivity of greater than or equal to 10⁶ Ω·cm at 25° C. Preferably, the composition exhibits a breakdown voltage of greater than or equal to 20 kV at 20° C. This ensures that the dielectric properties of the composition are compatible, from the viewpoint of safety, with use in direct contact with the battery.

The refrigerant makes it possible to reduce the viscosity of the dielectric fluid and optionally to render the composition more volatile and thus more efficient. The refrigerant also makes it possible to reduce the liquid saturation temperature of the composition (compared to a composition comprising only dielectric fluid) and to improve the efficiency of the cooling of the battery. Compared to a composition comprising only refrigerant, the invention makes it possible to reduce the constraints related to the pressure resistance of the facility.

Advantageously, the combination of refrigerant with the dielectric fluid also makes it possible to obtain compositions that are sparingly flammable or non-flammable.

### BRIEF DESCRIPTION OF THE FIGURES

FIG. 1 is a diagram which illustrates an embodiment of a battery assembly according to the invention.

FIG. 2 is a diagram which illustrates an embodiment of a battery assembly according to the invention.

FIG. 3 is a diagram which illustrates an embodiment of a battery assembly according to the invention.

FIG. 4 is a diagram which illustrates an embodiment of a battery assembly according to the invention.

FIG. 5 is a diagram which illustrates the variation of the liquid saturation temperature of the heat-transfer composition at a pressure of 1 bar, as a function of the content of refrigerant (see the examples section below). The temperature is represented on the ordinate (° C.) and the content of dielectric fluid is represented on the abscissa (% by weight).

### DETAILED DESCRIPTION

The invention is now described in more detail and in a nonlimiting way in the description which follows.

### Heat-Transfer Composition

The heat-transfer composition according to the invention comprises at least one refrigerant and at least one dielectric fluid.

The term “refrigerant” is understood to mean a fluid which is liable to absorb heat by evaporating at low temperature and low pressure and to discharge heat by condensing at high temperature and high pressure.

The refrigerant comprises a compound chosen from halogenated hydrocarbons, perhalogenated compounds, fluorinated ketones, fluorinated ethers and also their combinations.

The refrigerant can consist of one or more such compounds. Alternatively, it can also comprise one or more additional compounds chosen from hydrocarbons (alkanes or olefins, in particular propane, butane, isobutane, pentane, isopentane), CO₂ and oxygen-comprising hydrocarbons (in particular methoxymethane, ethoxyethane and methyl formate).

Preferably, the refrigerant consists of C₁, C₂, C₃, C₄ and/or C₅ compounds; more preferably C₁, C₂, C₃ and/or C₄ compounds.

Mention may be made, among halogenated hydrocarbons, of hydrofluorocarbons, hydrochlorofluorocarbons, hydrofluoroolefins, hydrochloroolefins and hydrochlorofluoroolefins.

By way of example, the refrigerant can be chosen from 1,1,1,4,4,4-hexafluorobut-2-ene (HFO-1336mzz, E or Z isomer), 1-chloro-3,3,3-trifluoropropene (HCFO-1233zd, E or Z isomer), 3,3,4,4,4-pentafluorobut-1-ene (HFO-1345fz), 2,4,4,4-tetrafluorobut-1-ene (HFO-1354mfy), 1,1,2-trifluoroethylene (HFO-1123), 2,3,3,3-tetrafluoropropene (HFO-1234yf), 1,3,3,3-tetrafluoropropene (HFO-1234ze, E or Z isomer, preferably E isomer), 1-chloro-2,3,3,3-tetrafluoropropene (HCFO-1224yd, E or Z isomer, preferably Z isomer), difluoromethane (HFC-32), 1,1,1,2-tetrafluoroethane (HFC-134a), 1,1,2,2-tetrafluoroethane (HFC-134), 1,1-difluoroethane (HFC-152a), pentafluoroethane (HFC-125), 1,1,1,3,3-pentafluoropropane (HFC-245fa), 1,1,1,2,3-pentafluoropropane (HFC-245eb), 1,1,1,2,3,3-hexafluoropropane (HFC-236ea), 1,1,1,3,3-pentafluorobutane (HFC-365mfc), fluoroethane (HFC-161), 1,1,1,2,3,3,3-heptafluoropropane (HFC-227ea), 1,1,1-trifluoropropane (HFC-263fb), 1,2-dichloroethylene (HCO-1130, E or Z isomer, preferably E isomer) and the combinations of these.

Preferred compounds are in particular HCFO-1233zd (preferably in E form), HFO-1336mzz (preferably in Z form) and HCFO-1224yd (preferably in Z form).

Perhalogenated compounds are composed of carbon atoms and of halogen atoms only. Mention may be made, for example, of perfluorinated compounds, such as dodecafluoropentane, tetradecafluorohexane, hexadecafluoroheptane and their combinations.

Mention may be made, among fluorinated ketones, for example, of fluorinated monoketones, perfluorinated monoketones, such as 1,1,1,2,2,4,5,5,5-nonafluoro-4-(trifluoromethyl)-3-pentanone, and their combinations.

Mention be made, among fluorinated ethers, for example, of hydrofluoroethers, such as methoxynonafluorobutane (HFE7100), ethoxynonafluorobutane (HFE-7200), 1-methoxyheptafluoropropane (HFE-7000), perfluoropolyethers and their combinations.

The refrigerant can comprise several, for example two, or three, or four, or five, compounds as described above.

For example, the refrigerant can consist (or consist essentially) of:
a mixture of HFO-1234yf and HFC-134a;
a mixture of HFO-1336mzz(Z) and HCO-1130(E);
a mixture of HFO-1234ze(E) and HFC-227ea;
a mixture of HFO-1234yf, HFC-134a and HFC-152a;
a mixture of HFC-32, HFC-152a and HFO-1234ze(E);
a mixture of CO₂, HFC-134a and HFO-1234ze(E);
a mixture of HFC-32, HFO-1234ze(E) and butane;
a mixture of HFC-32, HFC-125 and HFO-1234ze(E);
a mixture of HFC-32, HFC-125, HFO-1234yf, HFC-134a and HFO-1234ze(E);
a mixture of HFC-32, HFC-125, HFO-1234yf and HFC-134a;
a mixture of HFC-134a and HFO-1234ze(E);
a mixture of HFC-32, HFC-125 and HFO-1234yf;
a mixture of HFC-32 and HFO-1234yf;
a mixture of CO₂, HFC-32 and HFO-1234yf;
a mixture of HFC-32, HFC-134a and HFO-1234ze(E);
a mixture of HFC-32, HFO-1234yf and HFC-152a;
a mixture of HFC-32, HFO-1234yf and HFO-1234ze(E);
a mixture of HFC-32, HFC-125, HFC-134a and HFO-1234ze(E);
a mixture of HFC-32, HFC-125, HFC-134a and HFO-1234ze(E);
a mixture of CO₂, HFC-32, HFC-125, HFO-1234yf and HFC-134a;
a mixture of HFC-32, HFC-125, HFO-1234ze(E) and HFC-227ea;
and
a mixture of HFC-32, propane and HFO-1234yf.

Thus, the refrigerant can be a pure substance or a mixture. When it is a mixture, it is preferably an azeotropic or quasi-azeotropic mixture.

Preferred azeotropic compositions are the refrigerants:
R-513A (56% of HFO-1234yf and 44% of HFC-134a);
R-513B (58.5% of HFO-1234yf and 41.5% of HFC-134a);
R-514A (74.7% of HFO-1336mzz(Z) and 25.3% of HCO-1130(E));
R-515A (88% of HFO-1234ze(E) and 12% of HFC-227ea);
R-516A (77.5% of HFO-1234yf, 8.5% of HFC-134a and 14% of HFC-152a).

Alternatively, in certain embodiments, zeotropic compositions can be employed, and in particular the refrigerants:
R-444A (12% of HFC-32, 5% of HFC-152a and 83% of HFO-1234ze(E));
R-444B (41.5% of HFC-32, 10% of HFC-152a and 48.5% of HFO-1234ze(E));
R-445A (6% of CO₂, 9% of HFC-134a and 85% of HFO-1234ze(E));
R-446A (68% of HFC-32, 29% of HFO-1234ze(E) and 3% of butane);
R-447A (68% of HFC-32, 3.5% of HFC-125 and 28.5% of HFO-1234ze(E));
R-447B (68% of HFC-32, 8% of HFC-125 and 24% of HFO-1234ze(E));
R-448A (26% of HFC-32, 26% of HFC-125, 20% of HFO-1234yf, 21% of HFC-134a and 7% of HFO-1234ze(E));
R-449A (24.3% of HFC-32, 24.7% of HFC-125, 25.3% of HFO-1234yf and 25.7% of HFC-134a);
R-449B (25.2% of HFC-32, 24.3% of HFC-125, 23.2% of HFO-1234yf and 27.3% of HFC-134a);
R-449C (20% of HFC-32, 20% of HFC-125, 31% of HFO-1234yf and 29% of HFC-134a);
R-450A (42% of HFC-134a and 58% of HFO-1234ze(E));
R-451A (89.8% of HFO-1234yf and 10.2% of HFC-134a);
R-451B (88.8% of HFO-1234yf and 11.2% of HFC-134a);
R-452A (11% of HFC-32, 59% of HFC-125 and 30% of HFO-1234yf);
R-452B (67% of HFC-32, 7% of HFC-125 and 26% of HFO-1234yf);
R-452C (12.5% of HFC-32, 61% of HFC-125 and 26.5% of HFO-1234yf);
R-454A (35% of HFC-32 and 65% of HFO-1234yf);
R-454B (68.9% of HFC-32 and 31.1% of HFO-1234yf);
R-454C (21.5% of HFC-32 and 78.5% of HFO-1234yf);
R-455A (3% of CO₂, 21.5% of HFC-32 and 75.5% of HFO-1234yf);
R-456A (6% of HFC-32, 45% of HFC-134a and 49% of HFO-1234ze(E));
R-457A (18% of HFC-32, 70% of HFO-1234yf and 12% of HFC-152a);
R-459A (68% of HFC-32, 26% of HFO-1234yf and 6% of HFO-1234ze(E));
R-459B (21% of HFC-32, 69% of HFO-1234yf and 10% of HFO-1234ze(E));
R-460A (12% of HFC-32, 52% of HFC-125, 14% of HFC-134a and 22% of HFO-1234ze(E));
R-460B (28% of HFC-32, 25% of HFC-125, 20% of HFC-134a and 27% of HFO-1234ze(E));
R-460C (2.5% of HFC-32, 2.5% of HFC-125, 46% of HFC-134a and 49% of HFO-1234ze(E));
R-460A (12% of HFC-32, 52% of HFC-125, 14% of HFC-134a and 22% of HFO-1234ze(E));
R-463A (6% of CO₂, 36% of HFC-32, 30% of HFC-125, 14% of HFO-1234yf and 14% of HFC-134a);
R-464A (27% of HFC-32, 27% of HFC-125, 40% of HFO-1234ze(E) and 6% of HFC-227ea); and
R-465A (21% of HFC-32, 7.9% of propane and 71.1% of HFO-1234yf).

All the percentages shown are by weight.

In certain preferred embodiments, the refrigerant comprises HCFO-1233zd in E or Z form, and more preferably in E form.

Preferably, the heat-transfer composition according to the invention comprises essentially a single compound, as refrigerant. In this case, it is preferable for this refrigerant to be HFO-1233zd in E or Z form, and more preferably in E form.

Impurities can be present at up to, for example, 1% by weight at the most.

The refrigerant can in particular comprise, by weight:
at least 99.5% of HCFO-1233zd(E), preferably at least 99.7%, more preferably at least 99.8%;
a content of HFC-245fa of less than or equal to 500 ppm, preferably from 1 to 500 ppm, more preferably from 2 to 300 ppm;
a content of HFO-1234ze (E or Z) of less than or equal to 100 ppm, preferably from 1 to 100 ppm, more preferably from 2 to 50 ppm;
a content of HCFO-1233zd (Z) of less than or equal to 100 ppm, preferably from 1 to 100 ppm, more preferably from 2 to 50 ppm.

Other preferred compositions are:
a mixture consisting (or consisting essentially) of HCFO-1233zd(E) and of HFC-245eb, preferably a quasi-azeotropic or azeotropic composition;
a mixture consisting (or consisting essentially) of HFO-1366mzz(Z) and of HCO-1130(E), preferably a quasi-azeotropic or azeotropic composition, and more preferably the refrigerant R-514A.

The refrigerant according to the invention can in particular have a liquid viscosity of 0.1 to 2 cP at 20° C., preferably of 0.2 to 0.9 cP at 20° C. The viscosity can be measured according to the method indicated in example 2 below.

The refrigerant according to the invention can in particular have a liquid saturation temperature of 0 to 50° C., preferably of 10 to 30° C., in particular of 15 to 25° C., at 1 bar.

The refrigerant according to the invention can in particular have a density of 1 to 1.7, preferably of 1 to 1.5, preferably of 1 to 1.4, at 20° C.

The refrigerant according to the invention can in particular have a liquid saturation pressure of less than or equal to 2 bar at 30° C.

The term “dielectric fluid” is understood to mean, within the meaning of the present invention, a fluid, generally an oil, which does not conduct (or only sparingly conducts) electricity but allows electrostatic forces to be exerted.

The term “oil” is understood to mean a fatty substance which is in the liquid state at ambient temperature and which is immiscible with water. Oils are fatty liquids of vegetable, mineral or synthetic origin. It can be chosen from oils belonging to groups I to V as defined in the API classification (or their equivalents according to the ATIEL classification).

Insulating (dielectric) oils have characteristics of heat-exchange fluids and thus participate in the transfer of heat just like the refrigerant.

The oil included in the heat-transfer composition can be chosen in particular from mineral dielectric oils, synthetic dielectric oils, which are optionally biobased, and vegetable dielectric oils, and also their combinations.

Preferably, the dielectric fluid comprises at least one mineral dielectric oil. Nonlimiting examples of such mineral dielectric oils comprise paraffinic oils and naphthenic oils, such as the dielectric oils of the Nytro family, sold by Nynas (in particular Nytro Taurus, Nytro Libra, Nytro 4000X and Nytro 10XN), and Dalia, sold by Shell.

The mineral dielectric oils can preferably be paraffinic oils (that is to say, saturated linear or branched hydrocarbons), such as the Nytro Taurus oil sold by Nynas and the Dalia oil sold by Shell, or naphthenic oils (that is to say, cyclic paraffins), such as the Nytro Libra and Nytro 10XN oils sold by Nynas, aromatic compounds (that is to say, unsaturated cyclic hydrocarbons containing one or more rings characterized by double bonds alternating with single bonds) and non-hydrocarbon compounds.

Preferably, the dielectric fluid is an optionally biobased synthetic dielectric oil. Preferably, they can be aromatic hydrocarbons, aliphatic hydrocarbons, silicone oils, esters and polyesters, in particular polyol esters, and also mixtures of two or more of them in all proportions.

Mention may be made, among aromatic hydrocarbons, in a nonlimiting way, of alkylbenzenes, alkyldiphenylethanes (for example phenylxyxlyethane (PXE), phenylethylphenylethane (PEPE), monoisopropylbiphenyl (MIPB), 1,1-diphenylethane (1,1-DPE)), alkylnaphthalenes (for example diisopropylnaphthalene (DIPN)), methylpolyarylmethanes (for example benzyltoluene (BT) and dibenzyltolulene DBT) and their mixtures. In said aromatic hydrocarbons, it should be understood that at least one ring is aromatic and that optionally one or more other ring(s) present can be partially or completely unsaturated. Mention may be made in particular of the dielectric fluids sold by Soltex Inc., by Arkema under the name Jarylec®, and SAS 60E from JX Nippon Chemical Texas Inc.

Mention may be made, among aliphatic hydrocarbons, in a nonlimiting way, of alkanes, poly(α-)olefins (PAOs), for example polyisobutenes (PIBs), or olefins of vinylidene type, such as those sold, for example, by Soltex Inc.

The alkanes can in particular comprise at least 8 carbon atoms, for example between 8 and 22 carbon atoms, preferably between 15 and 22 carbon atoms.

The PAOs can be chosen from group IV and are, for example, obtained from monomers comprising from 4 to 32 carbon atoms, for example from octene or decene. The weight-average molecular weight of the PAO can vary quite widely. Preferably, the weight-average molecular weight of the PAO is less than 600 Da. The weight-average molecular weight of the PAO can also range from 100 to 600 Da, from 150 to 600 Da, or also from 200 to 600 Da. For example, PAOs exhibiting a kinematic viscosity, measured at 100° C. according to the standard ASTM D445, ranging from 1.5 to 8 mm²/s are sold commercially by Ineos under the brand names Durasyn® 162, Durasyn® 164, Durasyn® 166 and Durasyn® 168.

Mention may be made, among silicone oils, in a nonlimiting way, of linear silicone oils of polydimethylsiloxane types, such as, for example, those sold by Wacker under the name Wacker® AK.

Mention may be made, among synthetic esters, in a nonlimiting way, of esters of phthalic type, such as dioctyl phthalate (DOP) or diisononyl phthalate (DINP) (sold, for example, by BASF).

Mention may also be made, in a nonlimiting way, of esters resulting from the reaction between a polyalcohol and an organic acid, in particular an acid chosen from saturated or unsaturated C₄ to C₂₂ organic acids. Mention may be made, as nonlimiting examples of such organic acids, of undecanoic acid, heptanoic acid, octanoic acid, palmitic acid and their mixtures. Mention may be made, among the polyols which can be used for the synthesis of the abovementioned esters, as nonlimiting examples, of pentaerythritol for the synthesis of the oil Mivolt DF7, Midel 7131 and Mivolt DFK from M&I Materials.

The esters can, for example, be diesters of formula R^{a}—C(O)—O—([C(R)₂]ₙ—O)ₛ—C(O)—R^{b}, in which each R independently represents a hydrogen atom or a linear or branched C₁-C₅ alkyl group, in particular a methyl, ethyl or propyl group, especially a methyl group; s has the value 1, 2, 3, 4, 5 or 6; n has the value 1, 2 or 3; it being understood that, when s is other than 1, the n indices can be identical or different; and R^{a} and R^{b}, which are identical or different, represent, independently of each other, saturated or unsaturated and linear or branched hydrocarbon groups exhibiting a linear sequence of 6 to 18 carbon atoms. Preferably, when s and n are identical and have the value 2, at least one of the R groups represents a linear or branched C₁-C₅ alkyl group; and when s has the value 1 and n has the value 3, at least one of the R groups bonded to the carbon in the p position of the oxygen atoms of the ester functions represents a hydrogen atom.

The synthetic esters resulting from the reaction between a polyalcohol and an organic acid are, for example, Midel 7131 from M&I Materials or also the esters of the Nycodiel range from Nyco.

Mention may be made, among natural esters and vegetable oils, in a nonlimiting way, of the products from oily seeds or from other sources of natural origin. Mention may be made, by way of example and in a nonlimiting way, of FR3™ or also Envirotemp™, which are sold by Cargill, or also Midel eN 1215 sold by M&I Materials.

Use may also be made of a polyalkylene glycol (PAG), in particular obtained by polymerization or copolymerization of alkylene oxides comprising from 2 to 8 carbon atoms, in particular from 2 to 4 carbon atoms.

The heat-transfer composition according to the invention can comprise one oil or several oils, for example two, or three, or four, or five oils.

A preferred dielectric fluid is a polyol ester manufactured from pentaerythritol.

Another preferred dielectric fluid is a poly(α-)olefin (PAO) comprising predominantly (that is to say, to more than 50% by weight) isoparaffins comprising from 4 to 32 carbon atoms. This fluid belongs to group IV of the API classification.

Preferably, the heat-transfer composition according to the invention comprises a single dielectric fluid.

The dielectric fluid can in particular have a viscosity of 1 to 60 cP at 20° C. according to the standard ISO3104.

The dielectric fluid can in particular have a boiling point of greater than 30° C., as measured by ebulliometry.

The dielectric fluid can be present in the composition at a content of more than 0% to 80%, preferably more than 0% to 65%, preferably again of 10% to 45%, by weight, with respect to the total weight of the heat-transfer composition.

For example, this content can be from more than 0% to 5%; or from 5% to 10%; or from 10% to 15%; or from 15% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%; or from 70% to 75%; or from 75% to 80%, by weight, with respect to the total weight of the heat-transfer composition.

The refrigerant can be present in the composition at a content of 20% to less than 100%, preferably of 35% to less than 100%, more preferably of 55% to 90%, by weight, with respect to the total weight of the heat-transfer composition.

For example, this content can be from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%; or from 70% to 75%; or from 75% to 80%; or from 80% to 85%; or from 85% to 90%; or from 90% to 95%; or from 95% to less than 100%, by weight, with respect to the total weight of the heat-transfer composition.

In certain embodiments, the heat-transfer composition according to the invention comprises a polyol ester manufactured from pentaerythritol and at least one fluorinated or fluorochlorinated hydrocarbon, such as, for example, in a nonlimiting way, a hydrofluoropropane, a hydrofluoropropene, a hydrochlorofluoropropane, a hydrochlorofluoropropene and also their mixtures in all proportions.

In other embodiments, the heat-transfer composition according to the invention comprises a poly(α-)olefin (PAO) and at least one fluorinated or fluorochlorinated hydrocarbon, such as, for example, in a nonlimiting way, a hydrofluoropropane, a hydrofluoropropene, a hydrochlorofluoropropane, a hydrochlorofluoropropene and also their mixtures in all proportions.

Preferably, the heat-transfer composition according to the invention comprises HCFO-1233zd (preferably in E form) and a polyol ester manufactured from pentaerythritol. More preferentially still, the heat-transfer composition according to the invention consists essentially, indeed even consists, of HCFO-1233zd (preferably in E form) and a polyol ester manufactured from pentaerythritol.

Preferably, the heat-transfer composition according to the invention comprises HCFO-1233zd (preferably in E form) and a poly(α-)olefin (PAO). More preferentially still, the heat-transfer composition according to the invention consists essentially, indeed even consists, of HCFO-1233zd (preferably in E form) and a poly(α-)olefin (PAO). It can also consist essentially, or consist, of HCFO-1233zd in Z form, HFC-245eb and a PAO. It can also consist essentially, or consist, of HFO-1336mzz in Z form and a PAO. It can also consist essentially, or consist, of HFO-1336mzz in Z form, HCO-1130 in E form and a PAO.

The composition which can be used in the context of the present invention can additionally comprise one or more additives and/or fillers, for example chosen, in a nonlimiting way, from antioxidants, passivators, pour point depressants, decomposition inhibitors, fragrances and flavorings, colorants, preservatives and their mixtures. The presence of a decomposition inhibitor is particularly preferred.

Mention may be made, among the antioxidants which can advantageously be used in the composition, as nonlimiting examples, of phenolic antioxidants, such as, for example, dibutylhydroxytoluene, butylhydroxyanisole, tocopherols, and also the acetates of these phenolic antioxidants; antioxidants of amine type, such as, for example, phenyl-α-naphthylamine, of diamine type, for example N,N′-bis(2-naphthyl)-para-phenylenediamine, ascorbic acid and its salts, esters of ascorbic acid, alone or as mixtures of two or more of them or with other components, such as, for example, green tea extracts, coffee extracts.

A particularly suitable antioxidant is that commercially available from Brenntag under the trade name Ionol®.

The passivators which can be used in the context of the present invention are advantageously chosen from triazole derivatives, benzimidazoles, imidazoles, thiazole or benzothiazole. Mention may be made, by way of example and in a nonlimiting way, of dioctylaminomethyl-2,3-benzotriazole and 2-dodecyldithioimidazole.

Mention may be made, among the pour point depressants which can be present, as nonlimiting examples, of fatty acid esters of sucrose, or acrylic polymers, such as poly(alkyl methacrylate) or also poly(alkyl acrylate).

The preferred acrylic polymers are those with a molecular weight of between 50 000 g·mol⁻¹ and 500 000 g·mol⁻¹. Examples of these acrylic polymers include polymers which can contain linear alkyl groups comprising from 1 to 20 carbon atoms.

Mention may be made, among these, and still as nonlimiting examples, of poly(methyl acrylate), poly(methyl methacrylate), poly(heptyl acrylate), poly(heptyl methacrylate), poly(nonyl acrylate), poly(nonyl methacrylate), poly(undecyl acrylate), poly(undecyl methacrylate), poly(tridecyl acrylate), poly(tridecyl methacrylate), poly(pentadecyl acrylate), poly(pentadecyl methacrylate), poly(heptadecyl acrylate) and poly(heptadecyl methacrylate).

An example of such a pour point depressant is commercially available from Sanyo Chemical Industries Ltd under the trade name Aclube.

According to a very particularly preferred aspect, a decomposition inhibitor is present as additive. The decomposition inhibitor can be chosen in particular from carbodiimide derivatives, such as diphenylcarbodiimide, ditolylcarbodiimide, bis(isopropylphenyl)carbodiimide or bis(butylphenyl)carbodiimide; but also from phenyl glycidyl ethers, or esters, alkyl glycidyl ethers, or esters, 3,4-epoxycyclohexylmethyl 3,4-epoxycyclohexanecarboxylate, the compounds of the anthraquinone family, such as, for example, β-methylanthraquinone, sold under the name “BMAQ”, epoxide derivatives, such as vinylcyclohexene diepoxide, 3,4-epoxy-6-methylcyclohexylmethyl 3,4-epoxy-6-methylhexanecarboxylate, epoxy resins of phenol novolac type, bisphenol A diglycidyl ether epoxy, such as BADGE or CEL 2021P, which are available in particular from Whyte Chemicals.

The total amount of additives preferably does not exceed 5% by weight, in particular 4%, more particularly 3% and very particularly 2% by weight, indeed even 1% by weight, of the heat-transfer composition.

The composition according to the invention can be prepared according to any means well known to a person skilled in the art, for example by simple mixing of the various components of the composition according to the invention.

In certain embodiments, the heat-transfer composition contains impurities. When they are present, they can represent less than 1%, preferably less than 0.5%, preferably less than 0.1%, preferably less than 0.05% and preferably less than 0.01% (by weight), with respect to the heat-transfer composition.

The choice of the various components is not limiting provided that the heat-transfer composition according to the invention exhibits the properties (thermal conductivity, viscosity, resistivity, breakdown voltage, and the like) required for the targeted application. Preferably, a volume resistivity of greater than or equal to 10⁶ Ω·cm at 25° C., and preferably of greater than or equal to 10⁷ Ω·cm or 10⁸ Ω·cm. The resistivity of a material represents its ability to oppose the flow of electric current. In other words, the volume resistivity is an indication of the dielectric properties of the composition. The volume resistivity is measured according to the standard IEC 60247.

For example, this volume resistivity can be from 10⁶ to 5×10⁶ Ω·cm; or from 5×10⁶ to 10⁷ Ω·cm; or from 10⁷ to 5×10⁷ Ω·cm; or from 5×10⁷ to 10⁸ Ω·cm; or from 10⁸ to 5×10⁸ Ω·cm; or from 5×10⁸ to 10⁹ Ω·cm; or of more than 10⁹ Ω·cm.

Furthermore, the heat-transfer composition according to the invention preferably exhibits a breakdown voltage at 20° C. of greater than or equal to 20 kV, preferably of greater than or equal to 20 kV, preferably of greater than or equal to 30 kV, preferably of greater than or equal to 50 kV and more preferably of greater than or equal to 100 kV. The term “breakdown voltage” is understood to mean the minimum electrical voltage which renders a portion of an insulator conductive. Thus, this parameter is also an indication of the dielectric properties of the composition. The breakdown voltage is measured according to the standard IEC 60156.

For example, the breakdown voltage at 20° C. of the composition according to the invention can be from 25 to 30 kV; or from 30 to 40 kV; or from 40 to 50 kV; or from 50 to 60 kV; or from 60 to 70 kV; or from 70 to 80 kV; or from 80 to 90 kV; or from 90 to 100 kV; or from 100 to 110 kV; or from 110 to 120 kV; or from 120 to 130 kV; or from 130 to 140 kV; or from 140 to 150 kV.

The heat-transfer composition according to the invention can also exhibit a liquid saturation temperature of 20 to 80° C. and preferably of 30 to 70° C. at a pressure of 1 bar. For example, this temperature can be from 20 to 25° C.; or from 25 to 30° C.; or from 30 to 35° C.; or from 35 to 40° C.; or from 40 to 45° C.; or from 45 to 50° C.; or from 50 to 55° C.; or from 55 to 60° C.; or from 60 to 65° C.; or from 65 to 70° C.; or from 70 to 75° C.; or from 75 to 80° C.

The heat-transfer composition according to the invention can in particular have a viscosity of 0.1 to 20 cP at 20° C. according to the standard ISO 3104.

The heat-transfer composition according to the invention is preferably sparingly flammable (that is to say, exhibiting a high flash point, for example of greater than 150° C., or than 200° C., or than 250° C., or than 300° C., according to the standards ISO 3679 and ISO 3680) or more preferably nonflammable.

### Use of the Heat-Transfer Composition

With reference to FIG. 1, the battery 402 can feed at least one motor 404, in particular a vehicle engine. The vehicle is preferably an automobile, or possibly a construction machine, scooter, motorcycle, truck, ship, aircraft, and the like.

The battery can comprise a set of energy storage cells (or accumulators), which can be grouped together in a single or several modules. Each module can contain a plurality of cells arranged in a sealed enclosure. Each module enclosure can be configured in order to hold the cells in a fixed fashion.

The battery can comprise identical or different modules. The modules can be assembled together mechanically and/or connected electrically, to form the battery. The modules can be electrically connected in series, or in parallel.

Each enclosure can, for example, comprise an upper portion and a lower portion connected together, for example by welding, adhesive bonding or screwing.

The cells can, for example, be of cylindrical shape. Each module can comprise from 2 to 200 cells, preferably from 4 to 100 cells, more preferably from 6 to 50 cells. The cells can, for example, be arranged in N rows of M cells in each module. N can have a value, for example, from 1 to 10, for example can have the value 2. M can have a value, for example, from 1 to 60, and for example can be a multiple of 3 (namely 3, 6, 12, 18, 30, and the like). In certain embodiments, the cells can be ordered according to a three-dimensional arrangement in each module, with a stack of P layers of N×M cells. The number of layers P can then have a value, for example, from 2 to 5. Alternatively, a single layer is present.

The cells can, for example, be rechargeable nickel-cadmium (NiCd), nickel metal hydride (Ni-M-H) or lithium-ion (Li-ion) cells.

Each enclosure can, for example, be made of plastic, in particular of polystyrene, polyvinyl chloride, polycarbonate, polyethylene, polypropylene, acrylic polymer and in particular polymethyl methacrylate, phenolic resin, and the like. Alternatively, it can be made of metallic material, for example of aluminum.

The heat-transfer composition is used to cool a battery. This cooling is accomplished by placing the heat-transfer composition in direct contact with energy storage cells of the battery, the heat-transfer composition at least partially changing state (undergoing evaporation) on contact with the cells. In other words, the energy storage cells are immersed in the heat-transfer composition.

The term “immersed” is understood to mean that the cells are in contact with the heat-transfer composition. More particularly, the exterior surfaces of the cells are in contact with the heat-transfer composition. Preferably, they are in contact with the heat-transfer composition essentially in liquid form.

The cells can thus be arranged in a bath of heat-transfer composition. The heat-transfer composition can occupy the entire internal space of the module, between the cells and the wall of the enclosure, or preferably a gaseous headspace can be provided. Preferably, the entire surface of the cells in the enclosure is in contact with the composition in liquid form.

Alternatively, the surface of the cells can be covered with a liquid film obtained by virtue of suitable means (sprinkling, projection, jet, and like) and/or by specific treatment of the surface of the cells.

For example, the heat-transfer composition can be sprayed over the cells by monodirectional or multidirectional nozzles. They can, for example, be arranged between the cells so as to project the heat-transfer composition onto side faces of the cells. Alternatively, they are placed above the cells to project the heat-transfer composition onto upper faces of the cells. The composition can be projected in the form of a jet, or trickled, or be in the form of a mist. The composition can be recovered in a tank and recirculated by virtue of a pump. A heat exchanger and/or a heating means (for example resistor) can be arranged in the tank, or upstream or downstream of the pump, in order to make it possible to supply heat to or remove heat from the composition. In this alternative form, the operation of bringing the liquid composition into contact with the surface of the cells can be carried out only when there is a need to regulate the temperature of the battery. The rest of the time, and in particular when the battery is not in operation, the surface of the cells may not be in contact with the heat-transfer composition.

Optionally, the surface of the cells can be coated with a hydrophilic film in order to make it possible to distribute a liquid layer of heat-transfer composition over the surface of the cells. For example, a nanostructured SiO2 film can be employed. Alternatively, a filamentary or fibrous structure (comprising one or more rovings, or a woven or nonwoven textile), or also an agglomerated metal powder, can be arranged at the surface of the cells, in order to make it possible to distribute a liquid layer of heat-transfer composition over the surface of the cells by capillary action.

The heat-transfer composition is completely or partially vaporized on contact with the cells (in order to cool them).

Preferably, the change in state is partial: the dielectric fluid remains essentially in the liquid state, while the refrigerant undergoes a complete or partial change in state.

This makes it possible for the thermal properties of the heat-transfer composition to be used to best advantage. This is because cooling by direct contact of the cells of the battery with the heat-transfer composition is useful in the event of rapid charging of the battery, which involves the rapid heating of the latter. It makes it possible to keep the temperature uniformly in its optimal operating range.

The heat-transfer composition is contained in a device which is suitable for making possible the exchange of heat of the composition with the cells of the battery, and preferably also with a secondary source.

This device, with the battery itself, constitutes a battery assembly according to the invention.

The secondary source can be ambient air or an additional heat-transfer composition. When ambient air is concerned, one or more fans can be used to increase the exchange of heat with it.

The heat-transfer composition can be static or circulating.

If it is static, the device comprises the enclosure(s) containing the cells of the battery, as well as the heat-transfer composition in contact with these cells. The heat-transfer composition exchanges heat with the environment or an additional heat-transfer composition via the enclosure itself. The internal wall and/or the external wall of the enclosure can thus comprise heat-dissipation elements, such as fins or another structure in relief, in order to facilitate exchanges of heat with the environment or the additional heat-transfer composition. Preferentially, the heat-transfer composition can exchange heat with the additional heat-transfer composition, via a heat exchanger located in the enclosure, or directly via the wall of the enclosure, or via plates or channels on the wall of the enclosure.

For example, a condenser can be put into an upper wall of the enclosure. Thus, the heat-transfer composition which undergoes evaporation while cooling the cells can be condensed in this condenser, to return to liquid form. This condenser makes possible an exchange of heat with the ambient air or with an additional heat-transfer composition. The condenser can comprise channels put into the upper wall of the enclosure. Ridges, spikes or other protruding parts can help the condensed heat-transfer composition to trickle down to the lower part of the enclosure.

The pressure in the enclosure can vary depending on the temperature in the enclosure. The pressure in the enclosure can, for example, remain less than 5 bar, or less than 4 bar, or less than 2 bar.

When the heat-transfer composition is circulating, the device comprises a main heat-transfer circuit, as illustrated in FIG. 1.

The flow rate of the heat-transfer composition in the main circuit can be from 0 to 100 l/min, preferably from 5 to 50 l/min.

The enclosure of each module can be provided with at least one fluid inlet and at least one fluid outlet, to make it possible for the heat-transfer composition to pass through the enclosure, the cells being immersed, preferably entirely, in the heat-transfer composition.

To avoid thermal shocks, it may be preferred for the temperature of the heat-transfer composition, at the inlet of the enclosure, to be greater than or equal to 10° C., for example between approximately 20 and approximately 30° C.

To ensure better homogeneity of the thermal regulation of the battery, it may be preferred for the temperature glide (difference between the temperature of the heat-transfer composition at the outlet of the enclosure and the temperature of the heat-transfer composition at the inlet of the enclosure) to be, in absolute value, less than or equal to 10° C., preferably less than or equal to 5° C., more preferably less than or equal to 2° C., more preferably less than or equal to 1° C.

The modules can be fluidically connected in series, or in parallel, with respect to the circulation of the heat-transfer composition.

With reference again to FIG. 1, the main heat-transfer circuit can be configured to transport the heat-transfer composition originating from at least one heat exchanger 408, 408′ to the battery 402, and again from the battery 402 to the at least one heat exchanger 408, 408′. The module enclosure(s) are incorporated in this main circuit. The circulation in the main circuit can be carried out by convection. The main circuit can also comprise one or more pipes for supplying the heat-transfer composition to the battery and for collecting it; and possibly for transporting it between modules of the battery. Alternatively, the enclosures of the modules can be in direct contact so as to make possible the assembling of the respective fluid inlets and outlets of the modules. In this case, seals can be provided between the assembled inlets and outlets.

Distributors and collectors can be attached to or incorporated in the enclosures, when several fluid inlets and/or several fluid outlets are provided in each enclosure. In certain embodiments, portions of distributors and collectors can be formed in the enclosures themselves, so as to make possible the collection and distribution of the heat-transfer composition from one module to the other when the respective enclosures are assembled.

When the heat-transfer composition is used to cool the battery, it is completely or preferably partially vaporized as it passes through the enclosure(s).

Preferably, the change in state is made between a completely liquid composition and a two-phase liquid-vapor composition when passing through the battery, then again to a completely liquid composition (within the heat exchanger 408, 408′) before returning to the battery.

The transportation of the heat-transfer composition in the main circuit can be provided by one or more pumps 406. Preferably, the main circuit does not comprise a compressor: in other words, the heat-transfer circuit is not a vapor compression circuit.

The heat exchanger 408 can in particular be a radiator ensuring an exchange of heat with the ambient air.

Alternatively, the heat exchanger 408′ couples the main circuit with a secondary circuit in which an additional heat-transfer composition circulates, which composition itself exchanges heat with another source, for example with the ambient air.

The additional heat-transfer composition can be identical to or different from the heat-transfer composition. For example, it can be a refrigerant as described above, not mixed with a dielectric fluid. For example, the composition can comprise HFO-1234yf, combined, if appropriate, with one or more lubricants and other additives. Alternatively, it can be a mixture of water and glycol, for example.

This secondary circuit can be a refrigeration circuit, comprising a compressor, a pressure reducer, an evaporator and a condenser; or it can be a simple heat-exchange circuit devoid of compressor.

An expansion valve (for example an electronic expansion valve) can be provided upstream of the heat exchanger 408′ in this secondary circuit.

A pump can be provided in this secondary circuit in order to circulate the additional heat-transfer composition.

The additional heat-transfer composition can optionally change state, completely or partially, on passing through the heat exchanger 408′. Thus, if the heat-transfer composition is cooled in the heat exchanger 408′, the additional heat-transfer composition is correspondingly heated and can completely or partially evaporate (for example from a completely liquid state to a two-phase liquid-vapor state). Conversely, if the heat-transfer composition is heated in the heat exchanger 408′, the additional heat-transfer composition is correspondingly cooled and can completely or partially condense (for example from a two-phase liquid-vapor state to a completely liquid state).

Optionally, the secondary circuit can be reversible (that is to say that it can cool or heat the heat-transfer composition which is in contact with the battery, according to the operating mode).

The heat exchanger 408′ making possible the exchange of heat with the additional heat-transfer composition can, for example, be cocurrent or, preferably, countercurrent.

The term “countercurrent heat exchanger” is understood to mean a heat exchanger in which heat is exchanged between a first fluid and a second fluid, the first fluid at the inlet of the exchanger exchanging heat with the second fluid at the outlet of the exchanger, and the first fluid at the outlet of the exchanger exchanging heat with the second fluid at the inlet of the exchanger.

For example, countercurrent heat exchangers comprise devices in which the flow of the first fluid and the flow of the second fluid are in opposite or virtually opposite directions. Exchangers operating in crosscurrent mode with a countercurrent tendency are also included among countercurrent heat exchangers.

The heat exchangers can in particular be exchangers having U-shaped tubes, a horizontal or vertical tube bundle, spirals, plates or fins.

The additional heat-transfer composition can itself exchange heat with the environment, by means of an additional heat exchanger. It can optionally also be used to heat or cool the air in the passenger compartment of the vehicle. Thus, the heat dissipated by the battery can be absorbed by the air conditioning circuit of the vehicle.

To this end, the secondary circuit can comprise various branches having separate heat exchangers, the additional heat-transfer composition circulating or not circulating in these branches, depending on the operating mode. Optionally, alternatively or additionally, the secondary circuit can comprise means for changing the direction of circulation of the additional heat-transfer composition, for example comprising one or more three-way or four-way valves.

The main circuit can comprise a tank for the storage of the excess heat-transfer composition in liquid form.

The secondary circuit can comprise a tank for the storage of the excess additional heat-transfer composition in liquid form.

When the main circuit is equipped with a pump, protection can be provided, for example upstream of the pump, in order to ensure that only liquid is pumped to the battery. This is because, according to the external conditions (for example when the vehicle is hot on start-up due to the weather conditions), the heat-transfer composition may be two-phase upstream of the pump, in particular at the outlet of the tank. The protection can comprise a bypass system, in particular between the tank and the pump, with a valve, a pressure sensor and a temperature sensor. A filter and a dryer can be provided in order to capture impurities and moisture respectively.

It is possible to further provide a third circuit containing another additional heat-transfer composition, thermally connected to the secondary circuit, by a heat exchanger. This third circuit can in particular be dedicated to the recovery of the heat dissipated by the engine and/or the electrical components of the vehicle.

It is possible to provide two or more than two main circuits operated in parallel and controlled independently, in order to regulate the temperature of different modules of the battery or to control different batteries when there are several of them.

A system for management of the battery 410 can be combined with the battery 402, in order to measure the electrical parameters (in particular the voltage) but also the temperature of each module (by means of temperature sensors) and to control the modules as well as the main circuit (and optionally the secondary circuit), and in particular their pumps, in order to ensure that the electrical parameters in question and the temperature are within desired ranges.

Specific examples of thermal regulation systems comprising a main circuit and a secondary circuit are now described in more detail.

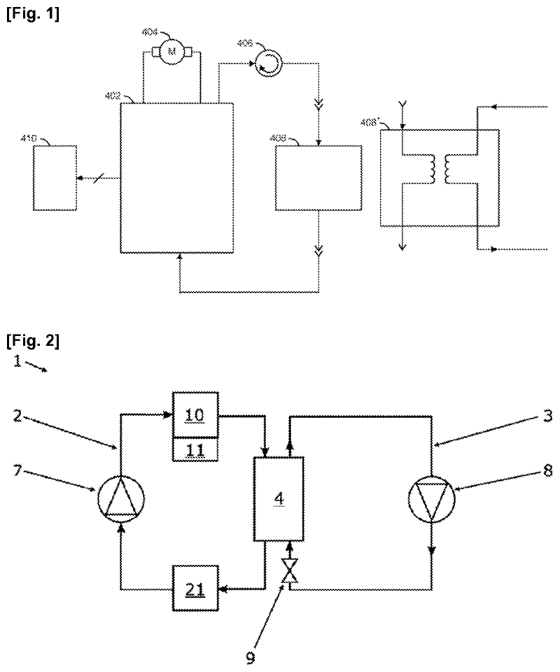

With reference to FIG. 2, an example of a battery assembly according to the invention (which can be used in particular in a vehicle) comprises a thermal regulation system 1 which comprises a main circuit 2 containing the heat-transfer composition described above and a secondary circuit 3 containing an additional heat-transfer composition, the two circuits being thermally connected by at least one heat exchanger 4. The heat-transfer composition in the main circuit 2 is set in motion by a pump 7 or by natural convection. The additional heat-transfer composition in the secondary circuit 3 is set in motion by a pump 8. The secondary circuit 3 comprises an expansion valve 9 making it possible to ensure the evaporation of the additional heat-transfer composition in the heat exchanger 4, in order to cool the heat-transfer composition of the main circuit 2.

At least one battery module 10 (as described above) is fluidically incorporated in the main circuit 2. A heating element 11 can be combined with the battery module 10 or incorporated in it.

When the circuit is equipped with a pump, a tank 21 can optionally be provided in the main circuit 2 in order to receive an excess of heat-transfer composition in liquid form.

In battery cooling mode, the pump 7 withdraws the heat-transfer composition from the tank 21 and sends it to the battery module 10. The heat-transfer composition is in the liquid state at the inlet of the battery module 10. It reaches its saturation temperature and is partially vaporized on passing through the battery module 10 and on absorbing the heat dissipated by the cells. It leaves the battery module 10 in a two-phase liquid-vapor state. The battery module 10 thus acts as evaporator with respect to the main circuit.

The two-phase heat-transfer composition subsequently passes through the heat exchanger 4. The additional heat-transfer composition is expanded in the expansion valve 9 and then completely or partially vaporizes in the heat exchanger 4. The heat-transfer composition condenses, transferring heat to the additional heat-transfer composition. The heat-transfer composition in liquid form subsequently returns to the tank 21.

The secondary circuit 3 can be the automotive air conditioning circuit of the vehicle (the compressor not being illustrated in the figure).

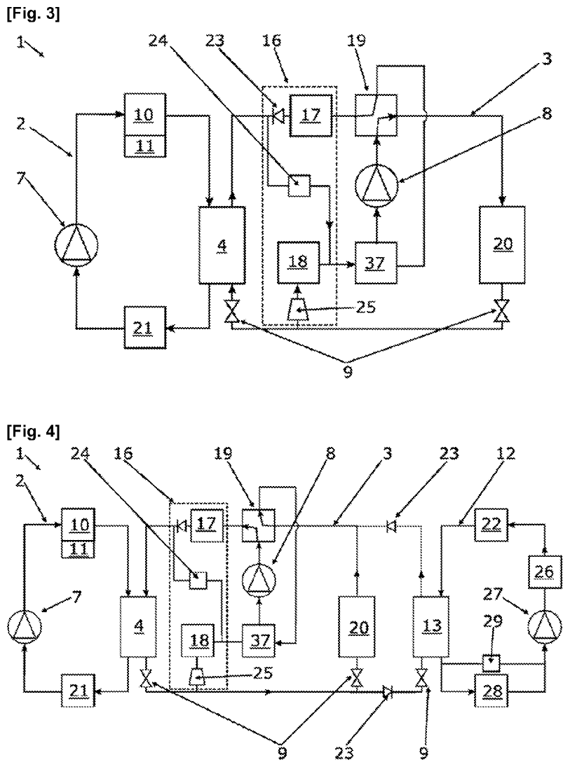

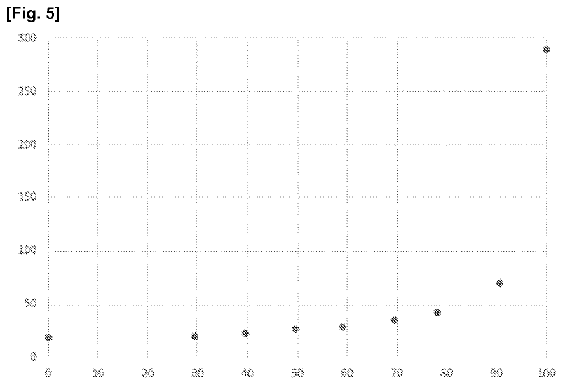

With reference to FIG. 3 and FIG. 4, an example of a battery assembly according to the invention (which can be used in particular in a vehicle) comprises a thermal regulation system 1 which comprises a main circuit 2 as described above and a secondary circuit 3 capable of operating as a reversible heat pump. Thus, the battery module 10 can be cooled and heated by the heat-transfer composition. The secondary circuit has two operating modes: a cooling mode and a heating mode. The cooling mode is illustrated in FIG. 3 and the heating mode is illustrated in FIG. 4.

The secondary circuit 3 comprises an HVAC module 16 (heating, ventilation and air conditioning) providing the thermal regulation of the air in the passenger compartment. It comprises a condenser 17 and an evaporator 18. The condenser 17 is used to heat the air in the passenger compartment and the evaporator 18 is used to cool it.

The secondary circuit 3 additionally comprises a control valve 19, a shut-off valve 24, a tank 37 and an external heat exchanger 20. An expansion valve 9 is arranged downstream of the external heat exchanger 20 and a calibrated orifice 25 with shut-off function is arranged upstream of the evaporator 18. The expansion valve 9, the shut-off valve 24 and the calibrated orifice 25 can be electrically controlled. The control valve 19 can be a reversible valve and/or a four-way valve capable of changing the direction of circulation of the additional heat-transfer composition.

In cooling mode, the control valve 19 is in a first position such that the external heat exchanger 20 is used as a condenser while the heat exchanger 4 and the evaporator 18 are used as evaporators. The shut-off valve 24 and the calibrated orifice 25 are open in this mode. The additional heat-transfer composition in the tank 37 is in a two-phase state and the pump 8 directs it to the external heat exchanger 20. The additional heat-transfer composition condenses in the latter and is directed to the heat exchanger 4 and the evaporator 18. In both cases, it is at least partially vaporized and returned to the tank 37.

In heating mode, the control valve 19 is in a second position such that the external heat exchanger 20 is used as an evaporator while the heat exchanger 4 and the condenser 17 are used as condensers. The shut-off valve 24 and the calibrated orifice 25 are closed in this mode. The additional heat-transfer composition in the tank 37 is in a two-phase state and the pump 8 directs it to the condenser 17 where it is partially condensed. It is then directed to the heat exchanger 4, where it continues to condense. It then passes through the external heat exchanger 20 having an evaporator function.

Optionally, a third circuit 12 can be provided and play a part in heating mode. The third circuit 12 can make it possible to recover heat dissipated by an engine 26 and/or electrical components 22 of the vehicle. It can comprise a pump and a radiator 28. A bypass fitted with a shut-off valve 29 can make it possible for the radiator 28 to be bypassed. The third circuit 12 is thermally connected to the secondary circuit 3 by a second heat exchanger 13. The third circuit can, for example, comprise a fluid such as a mixture of water and glycol. In heating mode, the additional heat-transfer composition, at the outlet of the heat exchanger 4, is distributed in the external heat exchanger 20 and in the second heat exchanger 13, both of which have an evaporator function. It thus absorbs the heat dissipated by the fluid of the third circuit 12.

The secondary circuit 3 can comprise two non-return valves 23 on the branch of the circuit comprising the second heat exchanger 13 (in parallel with the branch comprising the external heat exchanger 20), as well as an expansion valve 9 upstream of the second heat exchanger 13.

### Regulation of the Temperature

The invention relates to the use of a heat-transfer composition according to the invention for cooling the battery. However, the composition can also be usable, at other times, for heating the battery and remains mainly in liquid form. Heating and cooling can be alternated according to requirements (outside temperature, temperature of the battery, operating mode of the battery). Heating the battery is useful in particular on starting the vehicle, when the outside temperature is cold (for example less than 10° C., or than 0° C., or than −10° C., or than −20° C.).

The heating can also be carried out, at least partially, indeed even entirely, by means of an auxiliary heating element, for example an electrical resistor. The auxiliary heating element can be fitted to the battery.

It is thus possible to dedicate the heat-transfer composition according to the invention exclusively to the uniform cooling of the battery, whereas other means, for example an electrical resistor, are used for heating it.

Alternatively, it is possible to provide a heating element associated with the main circuit, in particular upstream of the battery. In this case, the heating element is liable to heat the heat-transfer composition, which subsequently heats the battery.

The term “temperature of the battery” is understood to mean generally the temperature of an outside wall of one or more of its electrochemical cells.

The temperature of the battery can be measured by means of a temperature sensor. If several temperature sensors are present at the battery, the temperature of the battery can be regarded as being the mean of the various temperatures measured. The invention makes it possible to considerably reduce the difference between the temperatures measured at different points of the battery.

Regulation of the temperature can be carried out when the battery of the vehicle is being charged. Alternatively, it can be carried out when the battery is being discharged, in particular when the engine of the vehicle is switched on. It makes it possible in particular to prevent the temperature of the battery from becoming excessive, because of the outside temperature and/or because of the characteristic overheating of this battery in operation.

In particular, the charging of the battery can be fast charging. Thus, during the complete charging of the battery (starting from a moment when the battery is completely discharged) over a period of time of less than or equal to 30 minutes, and preferably of less than or equal to 15 minutes, the use of the composition according to the invention makes it possible to keep the temperature of the battery in an optimum temperature range with a uniform distribution. This is advantageous given that, during fast charging, the battery tends to heat up rapidly and to reach high temperatures with in particular hot spots which can degrade its operation and its performance qualities and decrease its lifetime.

In certain embodiments, the cooling of the battery is continuous over a certain period of time.

In certain embodiments, the cooling and optionally the heating make it possible for the temperature of the battery to be maintained in an optimum temperature range, in particular when the vehicle is in operation (engine switched on), and especially when the vehicle is moving. This is because, if the temperature of the battery is too low, the performance of the latter is liable to decrease significantly.

In certain embodiments, the temperature of the battery of the vehicle can thus be maintained between a minimum temperature t₁ and a maximum temperature t₂.

In certain embodiments, the minimum temperature t₁ is greater than or equal to 10° C. and the maximum temperature t₂ is less than or equal to 80° C., preferably the minimum temperature t₁ is greater than or equal to 15° C. and the maximum temperature t₂ is less than or equal to 70° C., and more preferably the minimum temperature t₁ is greater than or equal to 16° C. and the maximum temperature t₂ is less than or equal to 50° C. For example, t₁ can be equal to 20° C. (indeed even greater than 20° C.) and t₂ can be equal to 40° C. (indeed even less than 40° C.).

A feedback loop is advantageously present, in order to modify the operating parameters of the facility as a function of the temperature of the battery which is measured, in order to ensure the maintenance of the temperature which is desired.

The outside temperature during the duration of the maintenance of the temperature of the battery of the vehicle between the minimum temperature t₁ and the maximum temperature t₂ can in particular be from −60 to −50° C.; or from −50 to −40° C.; or from −40 to −30° C.; or from −30 to −20° C.; or from −20 to −10° C.; or from −10 to 0° C.; or from 0 to 10° C.; or from 10 to 20° C.; or from 20 to 30° C.; or from 30 to 40° C.; or from 40 to 50° C.; or from 50 to 60° C.; or from 60 to 70° C.

The term “outside temperature” is understood to mean the ambient temperature outside the vehicle before and during the maintenance of the temperature of the battery of the vehicle between the minimum temperature t₁ and the maximum temperature t₂.

The invention also relates to the use of the heat-transfer composition described above to prevent, to delay or to limit the consequences of the runaway of the battery following a failure (for example a short circuit). The presence of a runaway is characterized by an uncontrolled increase in the temperature accompanied by a rapid generation of gas caused predominantly by the decomposition of the electrolyte, at a typical temperature of 150 to 200° C., resulting in the formation of CO, CO₂, HF and flammable entities, such as H₂, CH₄, C₂H₄, C₂H₆, C₂H₅F. The content of flammable gas can reach at least 30 mol % in the ejected gases.

Thus, the heat-transfer composition described above can be used to maintain the temperature of the battery at less than 150° C., preferably at less than 140° C., more preferably at less 140° C., more preferably at less than 130° C., in case of failure.

The heat-transfer composition described above can also be used to reduce or suppress the flammability of the gas mixture ejected in the event of runaway of the battery. In particular, it can be used to ensure that the content of flammable gases in the ejected gas mixture remains relatively low. It can be used to ensure that the content of refrigerant in the ejected gas mixture is greater than or equal to 30 mol %, preferably greater than or equal to 40 mol %, or greater than or equal to 50 mol %, or greater than or equal to 60 mol %, or greater than or equal to 70 mol %; in this embodiment, this refrigerant is chosen to be nonflammable, that is to say of class A1 in ASHRAE Standard 34; preferably, the refrigerant comprises or consists of HCFO-1233zdE.

### EXAMPLES

### Example 1—Miscibility and Dielectric Properties

Compositions were prepared by combining HCFO-1233zdE as refrigerant with a mixture of benzyltoluene and dibenzyltoluene (sold by Arkema under the name Jarylec® C101). It was first confirmed that the two products were miscible in all proportions.

The oil was charged by weighing out in a 0.2 L autoclave equipped with a magnetic stirrer and with a jacket in which a heat-exchange fluid circulates so as to homogenize the temperature in the gas phase and the liquid phase.

The autoclave was subsequently cooled down to −10° C., at which point the vacuum was drawn.

The HCFO-1233zdE contained in a cylinder was transferred in closed circuit mode as a liquid phase by weighing out.

The minimum volume of liquid charged was calculated in order for the composition of the liquid phase not to vary as a function of the temperature.

The final mixture was brought to the desired temperature with stirring in order to homogenize it. The stirring was subsequently switched off until the mixture reached equilibrium. The temperature and pressure were recorded at equilibrium.

FIG. 5 shows the influence of the content of refrigerant on the liquid saturation temperature of the composition at a saturated vapor pressure of 1 bar. More particularly, it is observed that, with respect to a composition comprising 100% of oil, the addition of refrigerant to the composition, even in a low content, makes it possible to markedly reduce the liquid saturation temperature of the composition, which makes it possible to increase the capability for the cooling of the battery.

A composition was prepared by mixing 69.2 g of HCFO-1233zdE and 100.5 g of Jarylec® C101 from Arkema, under the conditions presented below.

TABLE 1

| T autoclave | Pressure | |
|---|---|---|
| (° C.) | (bar abs) | Observations |
| 20 | 0.71 | miscible |
| 60 | 2.5 | miscible |

Another composition was prepared by mixing 35% by weight of HCFO-1233zdE and 65% by weight of Jarylec® C101 from Arkema, under the conditions presented below.

The breakdown voltage was measured according to the standard IEC 60159:1995.

TABLE 2

| | | | Breakdown |
|---|---|---|---|
| Jarylec ® C101 | R1233zd E | Resistivity at | voltage at 20° C. |
| (% by weight) | (% by weight) | 10° C. | (kV) |
| 100 | 0 | 3.12 × 10¹³ | 90 |
| 65 | 35 | 1.50 × 10¹² | 69.7 |
| 0 | 100 | 1.56 × 10¹⁰ | 47.3 |

### Example 2—Viscosity

Viscosity measurements were carried out in an autoclave reactor having a jacket in which a heat-exchange fluid circulates, with a capacity of 0.2 L, into which reactor Jarylec® C101 oil was introduced. The reactor was cooled to −10° C. and magnetically stirred. HCFO-1233zdE was then introduced by pressure difference. The reactor was subsequently brought to the measurement temperature.

The viscosity measurement was then carried out with a vibrating-rod viscometer, model MIVI 9601, of the Sofraser brand name. A camera made it possible to confirm the miscibility of the oil and the refrigerant under the conditions of the measurement and to verify the immersion of the rod of the viscometer, before taking the measurement.

TABLE 3

| | | | | |
|---|---|---|---|---|
| Content of HCFO-1233zdE | 0% | 10% | 0% | 10% |
| T (° C.) | 20 | 20 | 0 | 0 |
| Dynamic viscosity (cP) | 6.0 | 3.9 | 12 | 6.5 |

By way of comparison, a viscosity measurement according to the standard ISO 3104 was carried out on the oil (0% of HCFO-1233zdE) at 20° C. The value obtained is 6.5 cP.

### Example 3—Flammability

A flash point measurement was carried out on a composition containing 90% by weight of Jarylec® C101 oil and 10% by weight of HCFO-1233zdE, and also on a comparative composition containing 100% by weight of Jarylec® C101 oil.

The mixture was prepared at low temperature, under atmospheric pressure. It is homogeneous and liquid at ambient temperature and atmospheric pressure.

The measurement of the flash point was carried out according to the standard ISO 3679 or ISO 3680, “Flash/no-flash type flash point test—rapid equilibrium closed cup method”. The standardized tests are carried out with the filling port left free, thus open and breathing to the atmosphere, the dish being closed.

The tests were adapted as the case may be by blocking the filling port so as to be able to simulate an even more confined device during the equilibrium in temperature (2 minutes under standardized conditions). In this case, the tests are carried out with “lid blocked”.

The temperature range explored went up to 300° C.

TABLE 4

| | | |
|---|---|---|
| Content of HCFO-1233zdE | 0% | 10% |
| Flash point | 138° C. | Not detected |

### Example 4—Heat-Transfer Coefficient (Two-Phase Immersion)

In order to carry out heat-transfer coefficient measurements, a test device placed in a thermal regulation chamber is used to measure the performance qualities of fluids by varying the ambient temperature. The test device comprises a container equipped with a heating element and with a condenser. The condenser is located at the top of the container and is cooled by a loop of ice-cold water. The heating element is a cylindrical resistor 15 mm in diameter and 80 mm in height in a copper sheath, which is immersed vertically in a cylinder filled with saturated liquid in order to heat it. It can deliver up to 15 W/cm². Eight temperature sensors are placed on the copper sheath to measure the surface temperature.

Two different mixtures of an oil, the properties of which, in particular the viscosity, are similar to those of Jarylec® C101 oil, and the properties of which, in particular the thermal (thermal conductivity greater than 0.05 W/(m²·K) and dielectric properties, meet the specifications for this application, and of HCFO-1233zdE were tested. The HCFO-1233zdE was introduced first while avoiding any introduction of moisture or pollution of the air. The oil was added by gravity with a graduated cylinder. The miscibility and the homogeneity were checked by sampling.

The temperature of the cooling water (temperature of 10° C. at the condenser) and the flow rate were set to the desired values. The ambient temperature was set at 26° C. The thermal power was increased from 0 to 90 W in increments of 5 W and then decreased again for the detection of hysteresis. A mean value of heat-transfer coefficient was measured during the rise in temperature: H=F/(T_{w}−Tₛₐₜ), with F being the heat flux density, T_{w} the temperature of the wall and Tₛₐₜ the liquid saturation temperature of the composition measured.

TABLE 5

| | | | | | |
|---|---|---|---|---|---|
| HCFO-1233zdE (% by weight) | 30 | 60 | 30 | 60 | 60 |
| F (W/cm²) | 0.5 | 0.5 | 1.5 | 1.5 | 2.5 |
| H (W/(m² · ° K)) | 197 | 573 | 441 | 973 | 1548 |

### Example 5—Prevention of Runaway

A test was carried out in a compact assembly of 8 energy storage cells, housed in a sealed enclosure filled with a fluid A (pure HCFO-1233zdE) or with a fluid B (60% of HCFO-1233zdE+40% of aliphatic hydrocarbon dielectric oil, by weight). The enclosure is equipped with a valve calibrated for a pressure greater than the vapor pressure of the fluid at 50° C.

The test is equipped with thermocouples for monitoring the temperatures of the wall of the cells and of the fluid. The ejected gases are analyzed by gas chromatography after washing to remove the acid products.

The characteristics of the cells are as follows:
Model: Samsung INR 18650 35E.
Electrical architecture: 1s8p.
Capacity: 3.5 A·h.
Chemistry: LiNiCoMnO₂.
Voltage: 2.5 V minimum, 3.6 V nominal, 4.2 V maximum.

At time t=0, a short circuit is created on one of the cells charged to the maximum by means of a nail. The cell concerned then undergoes thermal runaway, which is reflected by an increase in the pressure and an opening of the valve of the enclosure.

In the case of the fluid A, the calibration pressure of the valve is 4 bar absolute. The content of HCFO-1233zd in the ejected gases is greater than 60 mol %.

Analysis of the gases does not reveal any degradation of the HCFO-1233zd.

The runaway is not propagated to the other cells, which remain intact.

In the case of the fluid B, the calibration pressure of the valve is 3 bar absolute. The content of HCFO-1233zd in the ejected gases is greater than 50 mol %. The runaway is not propagated to the other cells, which remain intact. Analysis of the gases does not reveal any degradation of the HCFO-1233zd, nor any reaction with the oil.

1. The use of a heat-transfer composition comprising from 20% to less than 100% by weight of a refrigerant comprising a compound chosen from halogenated hydrocarbons, perhalogenated compounds, fluorinated ketones, fluorinated ethers and also their combinations, and from more than 0% to 80% by weight of a dielectric fluid, for cooling a battery, the battery comprising energy storage cells immersed in the heat-transfer composition, and the heat-transfer composition undergoing evaporation on contact with the energy storage cells.

2. The use as claimed in claim 1, in which the heat-transfer composition circulates in a heat-transfer circuit.

3. The use as claimed in claim 2, in which the battery comprises one or more modules each comprising an enclosure in which energy storage cells are arranged, the enclosure(s) forming part of the heat-transfer circuit.

4. The use as claimed in claim 2, in which the heat-transfer circuit is thermally coupled to a secondary circuit containing an additional transfer composition.

5. The use as claimed in claim 4, in which the secondary circuit is the air conditioning circuit of a vehicle; and/or is a reversible heat pump circuit.

6. The use as claimed in claim 1, in which the refrigerant comprises or is 1-chloro-3,3,3-trifluoropropene or is a binary mixture or of 1,1,1,4,4,4-hexafluorobut-2-ene in the Z form and of 1,2-dichloroethylene in the E form.

7. The use as claimed in claim 1, in which the dielectric fluid is chosen from mineral dielectric oils, synthetic dielectric oils and vegetable dielectric oils.

8. The use as claimed in claim 1, in which the battery is the battery of an electric or hybrid vehicle.

9. The use as claimed in claim 1, implemented during the charging of the battery of the vehicle.

10. A battery assembly, in particular for an electric or hybrid vehicle, comprising one or more modules each comprising an enclosure in which are arranged energy storage cells immersed in a heat-transfer composition, the heat-transfer composition comprising from 20% to less than 100% by weight of a refrigerant comprising a compound chosen from halogenated hydrocarbons, perhalogenated compounds, fluorinated ketones, fluorinated ethers as well as their combinations, and from more than 0% to 80% by weight of a dielectric fluid, the battery assembly being configured so that the heat-transfer composition undergoes evaporation in order to cool the battery.

11. The battery assembly as claimed in claim 10, comprising a heat-transfer circuit in which the heat-transfer composition circulates, the enclosure(s) of the module(s) being incorporated in this heat-transfer circuit.

12. The battery assembly as claimed in claim 11, in which the heat-transfer circuit comprises a pump; and/or in which the heat-transfer circuit comprises a heat exchanger in order to make possible heat exchange of the heat-transfer composition either with the ambient air or with a heat-transfer composition in a secondary circuit.

13. The battery assembly as claimed in claim 10, in which the refrigerant comprises or is 1-chloro-3,3,3-trifluoropropene or is a binary mixture or of 1,1,1,4,4,4-hexafluorobut-2-ene in the Z form and of 1,2-dichloroethylene in the E form.

14. The battery assembly as claimed in claim 10, in which the dielectric fluid is chosen from mineral dielectric oils, synthetic dielectric oils and vegetable dielectric oils.

15. A method of regulation of the temperature of the battery of the battery assembly as claimed in claim 10, comprising the cooling of the energy storage cells by the heat-transfer composition by partial evaporation of the heat-transfer composition.
